(19) United States
(12) Patent Application Publication
(10) Pub. No.: US 2012/0167322 A1
(43) Pub. Date: Jul. 5, 2012

(54) Multifunctional brush especially for the back skin self care

(76) Inventors: Edward Jaworski, Delta (CA); Daniel Grzegorz Jaworski, Vancouver (CA)

(21) Appl. No.: 12/930,156

(22) Filed: Dec. 30, 2010

(51) Int. Cl. A47K 7/02; A46B 5/00; B25G 1/10

(52) U.S. Cl. 15/144.1

(57) ABSTRACT

Presented here invention provides the brush with specifically shaped and adjustable handle that allows holding the apparatus in the front of the body to provide efficient functions of self washing, massaging and scratching the skin of the back of the body. The handle is divided into two parts, the lower and the upper. The lower handle has a brush at one end and the gripping portion at the upper end. There is also a pivotal disc above the gripping portion of the lower handle. The upper handle contains the gripping portion at one end and the pivotal disc at the other end. Both pivotal discs are connected together by a nut. The pivotal connection allows the brush to be used in the open position, as well as, the closed position. When the brush is in the open position it will be used for maneuvering it at the back of the body. The closed position will allow using it as a traditional brush with the straight handle and also for the convenient storage. The pivotal connection allows for the adjustment of the angle between the upper handle and the lower part in order to accommodate different sizes of bodies.

### BACKGROUND OF THE INVENTION

While discussing inconveniences of the back skin self care especially among older and inflexible people it was stated that existing brushes with their straight and non-adjustable handles are unable to provide sufficient pressure and access to the body as we are lacking the proper muscle and flexibility in our arm. Also holding a straight handle brush to the back restricts easy reaching to all parts of the body regardless of the length of the handle or slight alterations to the mainly straight shape. With a dose of amusement it was observed that the concept of the handle conveniently held at the front of the body was nowhere to be found in the previous designs of the self brushing apparatuses. The future research has revealed a few designs offered by the market. One of them in the form of rubbing band and another as a brush fastened to the wall of the shower. It is believed that the first one will be insufficient to provide some harder pressure massage to the all sections of the back body and the second one being impractical and also unsafe. Upon review of the previous US patents in the field of brushes, skin care and hygiene it became apparent that none of the previous inventions in those fields can be cited as a close relation to the one presented here.

### References Cited

### U.S. Patent Documents

| | | |
|---|---|---|
| 2006/0236473 A1 | October 2006 | Jaffe |
| 2007/0095362 A1 | May 2007 | Koopah |
| 2009/0159487 A1 | June 2009 | Tacoma |
| 7716775 B2 | May 2010 | Di Pietro et al. |

### SUMMARY OF THE INVENTION

Presented here brush is convenient for the use for back skin hygiene and is unique to those produced before. It is believed that when manufactured correctly it will become a very popular item in everyone's bathroom. The preferable design of the brush should provide firm yet flexible bristles able to provide a massaging sensation while washing at the same time. In between the widely spaced massaging bristles or together with them there should be inserted hairy elements which will allow containing applicable soap. The scraping element added to the brush can be offered as an optional for the purpose of death skin removal as well as scratching the back. It is also believed that presented here brush has no limitations to mentioned here applications and can be adopted to provide another functions like for example self application of the lotion to the back skin of the body. Fully extended brush handle with angle α reaching 180 deg will help inflexible people to wash their feet or a bathtub and shower walls. Easily detachable upper part of the handle allows using brush as a traditional with the straight handle alone or with upper handle folded beside. The angle α between lower and upper handle for most of the users will be slightly smaller than 90 deg what makes it easier to apply decent pressure of the brush to the back skin. This angle can be altered within wide range to fit individual needs of those like elders or suffering from injury. The elevated left side of the upper handle and the drop of the right side to the position slightly downward from horizontal gives the brush handle unique shape and makes it optimal for unrestricted maneuvering at the back of the body. This was proven by several tryouts with the handles of different shapes.

### DESCRIPTION OF THE DRAWINGS

FIG. 1 It is the side view of the brush which shows all the parts of the brush and their connections. Straight handle 1 has integrally connected brush at the bottom end and pivotal disc as well as a gripping portion at the upper end. In the back of the brush there are two dove tail shape slides. In between of those slides is inserted a scratcher 3. The pivotal disc at the top of the handle has the round hole in the centre through which protrudes a threaded pin of the upper handle 2. The upper handle 2 has a pivotal disc at the lover end and a gripping portion at the upper end. Pivotal discs of the both handles are radially serrated on the connecting surfaces to avoid sliding between them. The nut 4 tightens both discs together. In broken line are shown two more upper handle positions. One lowered slightly for the shorter person and one lowered completely for using the brush as traditional one with the straight handle or as for the storage.

FIG. 2 It is back view of the brush paddle which shows dovetail shape of the slides and inserted in between them back portion of the scratcher.

FIG. 3 It is front view of the scratcher. It shows it shape which imitates human fingernails with the centre one being slightly lower than outside ones.

FIG. 4 It is the cross section of the brush paddle to show that the inner walls of the slides have an inward angles and the back portion of the scratcher has an outward angles for a better connection between them. The brush bristles are not shown.

FIG. 5 It is the cross section at the pivotal connection of the lower and the upper handle. It shows both discs tightened by nut 4. The serration of both discs is shown here as parallel instead of radial one for the better illustration.

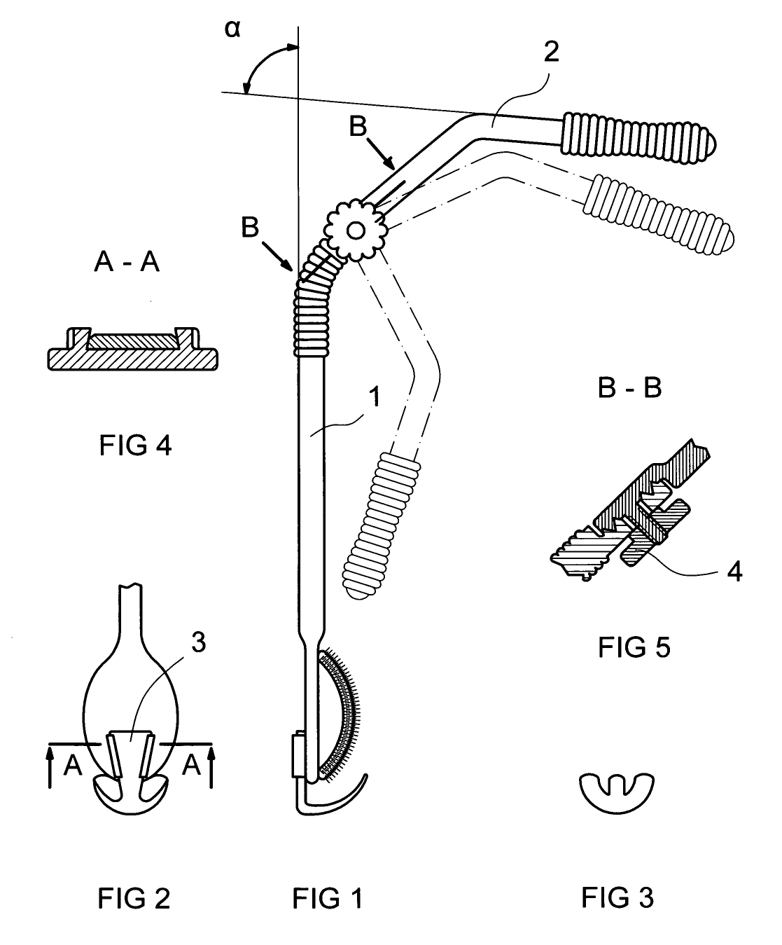

1. Presented here brush has specifically shaped handle which is held at the front of the body and allows brush to be freely maneuvered at the entire back of the body with the ability to apply sufficient pressure of the brush to the body.

2. The brush handle is divided into two parts connected in the pivot point what allows using the brush in the open position as the back body brush and in the closed position as the traditional brush, as well as, accommodates angular adjustment of the upper handle for the different sizes of the human body.

3. The top of vertically oriented brush handle is bending sideways and upward at the substantial angle and then is bending downward along the slightly shorter length and slightly below the horizontal position with the dimensions of the side portion of the handle comparable to the dimensions of the human torso of average build.
